(19) United States
(12) Patent Application Publication
(10) Pub. No.: US 2019/0178779 A1
(43) Pub. Date: Jun. 13, 2019

(54) APPARATUS AND METHOD FOR MEASURING A CHARACTERISTIC OF AN ANALYTE PARTICLE

(71) Applicant: Game Changers, LLC, New York, NY (US)

(72) Inventors: Sergey F. GIMELSHEIN, San Jose, CA (US); Eugene MOSKOVETS, Boxboro, MA (US); Piotr A. GARBUZ, Palo Alto, CA (US)

(73) Assignee: Game Changers, LLC, New York, NY (US)

(21) Appl. No.: 16/215,050

(22) Filed: Dec. 10, 2018

Related U.S. Application Data
(60) Provisional application No. 62/596,343, filed on Dec. 8, 2017.

(51) Int. Cl. G01N 15/10

(52) U.S. Cl. CPC G01N 15/1056

(57) ABSTRACT

An apparatus and a method are disclosed for measuring a characteristic of an analyte particle. An apparatus for measuring a characteristic of an analyte particle includes a heat flux sensor configured to be maintained at a temperature. The heat flux sensor includes first and second electrical connections, and a top interconnect membrane bridging the first and second electrical connections. The apparatus further includes an emitter configured to eject an analyte particle to cause the analyte particle to collide with the top interconnect membrane of the heat flux sensor.

### CROSS-REFERENCE TO PRIORITY APPLICATION

This application claims the benefit of Provisional U.S. Patent Application Ser. No. 62/596,343 filed on Dec. 8, 2017, the entire contents of which are incorporated herein by reference.

### FIELD

The present disclosure relates to an apparatus and method for measuring a characteristic of an analyte particle. Aspects of the present disclosure generally relate to devices and methods for analyzing gas species through the measurement of absolute species concentration, mass, and/or heat capacity of their constituent particles, which can be atoms, molecules, and nanoscale particulates. Aspects of the present disclosure are relevant at least to the fields of mass spectrometry, gas chromatography, and atomic interferometry. Aspects of the present disclosure have applications, for example, in molecular composition identification and gas species concentrations measurements, as well as in determining composition of surfaces and solids, when used with known techniques for gasification of solids.

### BACKGROUND INFORMATION

Conventional methods of identifying the chemical composition of a specific molecular species involve the determination of its mass. There are two main conventional methods for the direct determination of atomic and molecular weights: mass spectrometry and atomic interferometry.

In a typical mass spectrometer, molecules or particles are first ionized, and the produced ions are then sent to a mass analyzer that separates the ions in time (see for instance U.S. Pat. No. 2,612,607, incorporated herein by reference for its description of a mass spectrometer), frequency domain (see for instance U.S. Pat. No. 3,937,955, incorporated herein by reference for its description of a mass spectrometer), or space (see for instance U.S. Pat. No. 3,946,227, incorporated herein by reference for its description of a mass spectrometer) in accordance with their m/z ratio, where m is the ion mass and z is its charge. The exact chemical composition is obtained through database search of known substances, thus allowing one to identify the compound. Modern mass spectrometers can typically measure masses m with high precision, Δm, so that Δm/m is below 1e-6. In addition, mass spectrometers are typically capable of direct measurements of low relative concentrations of particles from gaseous or liquid samples, down to several parts per trillion. There is however several disadvantages associated with mass spectrometers as chemical analysis tools. The main disadvantage is that the mass spectrometers can be very bulky, typically several cubic feet. They also require an ionization source, and as the ionization efficiency of a particular species is not a priori known, the actual concentration of the given substance in a sample cannot be determined without using isotopically labeled standards. Moreover, ionization of many substances can be very inefficient, and may lead to substance fragmentation.

To avoid uncertainties related to ionization efficiencies, one known way of accurately measuring masses of neutral molecules (without ionization) is atomic interferometry (see S. Gerlich et al. “A Kapitza-Dirac-Talbot-Lau interferometer for highly polarizable molecules”, 2007, Nature Physics 3, 711-715, 2007, incorporated herein by reference for its description of mass measurements of neutral molecules). In the method described in Gerlich et al., particles to be analyzed (i.e., analyte particles), are suspended in gas phase, and a nearly parallel molecular beam is formed from these molecules. Then, this beam passes through a set of diffraction gratings, mechanical and optical, placed perpendicular to the beam. When passing through optical gratings, the molecules of the beam interact with photons of a known wavelength generated by a highly coherent optical source. When passing optical diffraction gratings or similar elements, the molecules are subjected to the action of high electric-field gradients that shift the molecules in the direction orthogonal to that of the molecular beam. The sequential interactions of beam molecules with the optical diffraction gratings change the spatial distribution of molecules depending on their polarizability and mass. That spatial distribution is measured and analyzed after the molecules pass the last grating, and the molecular weight is then derived. While atomic interferometers are capable of providing high accuracy of measurement of neutral particle masses, they are extremely bulky and cannot be applied to mass analysis of complex molecular mixtures.

### SUMMARY

An apparatus is disclosed for measuring a characteristic of an analyte particle. The apparatus comprises a heat flux sensor configured to be maintained at a temperature. The heat flux sensor includes first and second electrical connections, and a top interconnect membrane bridging the first and second electrical connections. The apparatus further includes an emitter configured to eject an analyte particle to cause the analyte particle to collide with the top interconnect membrane of the heat flux sensor.

A method is also disclosed for measuring a characteristic of an analyte particle. The method comprises maintaining a sensing surface at a temperature, ejecting an analyte particle to cause the analyte particle to collide with the sensing surface, detecting heat flux of the sensing surface due to the analyte particle colliding with the sensing surface, and determining a characteristic of the analyte particle based on the detected heat flux of the sensing surface.

In an exemplary embodiment, the apparatus is a miniature high sensitivity device for analyzing particles by measuring their absolute species concentration, masses and/or heat capacities. The apparatus uses an array of nanoscale thermoelectric junctions to detect energies of impinging atoms, molecules, and/or nanoparticles. The particles to be analyzed are introduced into or created in a stagnation chamber through heating and evaporation or other non-ionizing mechanisms, and mixed with the carrier gas which then expands into the detection chamber through a supersonic nozzle. In the detection chamber, aerodynamically accelerated analyte particles interact with the thermoelectric sensor array and then are removed from the detection chamber by a pump. Such a system can provide accuracy of mass measurement better than 1% and operate in a continuous or a pulsed regime at ambient pressure.

One benefit of aspects of the present disclosure is the ability to simultaneously analyze a large number of neutral species and a size small enough to be used in a compact device.

### BRIEF DESCRIPTION OF THE DRAWINGS

Other features and advantages disclosed herein will become more apparent from the following detailed description of exemplary embodiments when read in conjunction with the attached drawings.

FIG. 1 shows an exemplary embodiment of an apparatus for measuring a characteristic of an analyte particle.

FIG. 2 shows an exemplary embodiment of a heat flux sensor array of an apparatus for measuring a characteristic of an analyte particle.

FIG. 3 shows an exemplary embodiment of a heat flux sensor of an apparatus for measuring a characteristic of an analyte particle.

FIG. 4 shows a graphical representation of energy distribution of two molecular species of different masses.

### DETAILED DESCRIPTION

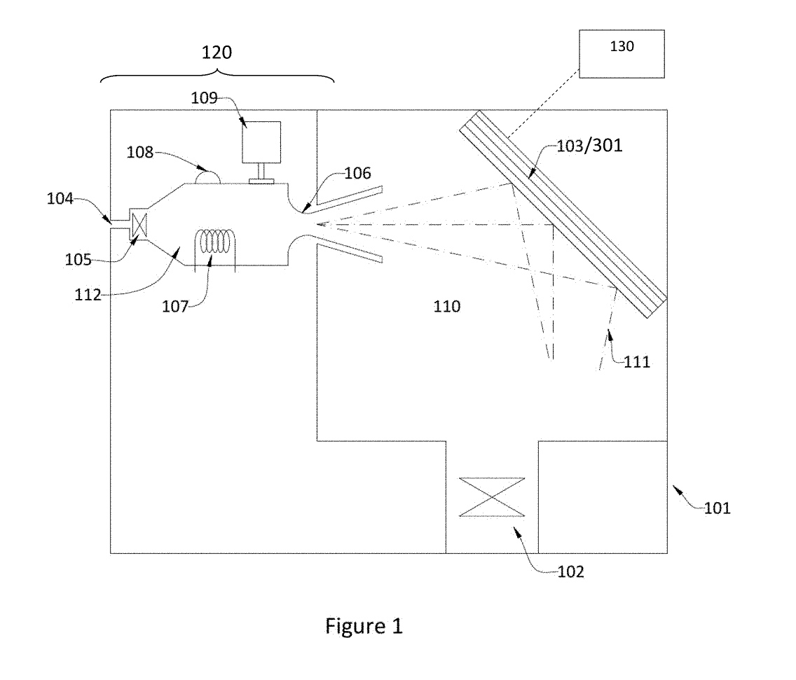

FIG. 1 shows an exemplary embodiment of an apparatus 101 for measuring a characteristic of an analyte particle. The paths 111 shown in FIG. 1 follow exemplary paths of analyte particles.

The term “analyte particle” herein refers to, for example, an atom, a molecule, or a nanoparticle.

The term “membrane” herein refers to a material which is less than 10 nm in thickness.

The term “nanoscale” herein refers to a feature which is less than or equal to 100 nm in width or diameter.

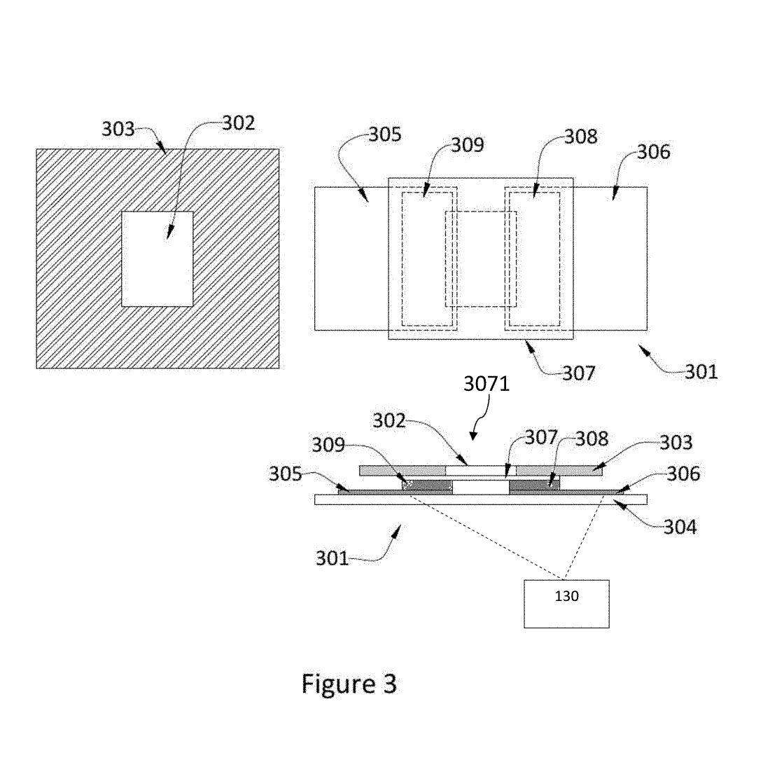

In an exemplary embodiment, the apparatus 101 comprises a heat flux sensor 301 configured to be maintained at a temperature, the heat flux sensor (301) including first and second electrical connections (305, 306), and a top interconnect membrane (307) bridging the first and second electrical connections (305, 306) (shown in FIG. 3).

In an exemplary embodiment, a thermoelectric heat flux sensor 301 can be replaced or augmented with a thermopile, a thermistor, a bolometer, and/or any other high sensitivity heat flux sensor calibrated to measure heat flux.

In an exemplary embodiment, the apparatus 101 comprises an emitter 120 configured to eject an analyte particle to cause the analyte particle to collide with the top interconnect membrane 307 of the heat flux sensor 301.

In an exemplary embodiment, the apparatus 101 comprises a heat flux sensor array 103 including a plurality of sensors 301, one of which is the above-described heat flux sensor 301.

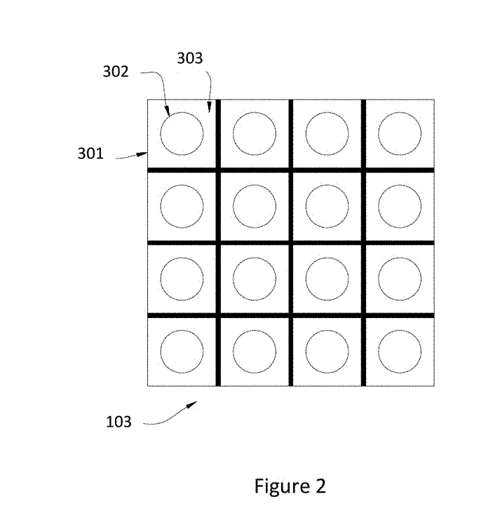

An exemplary embodiment of an array 103 of nanoscale-size sensors 301 is shown in FIG. 2. The array 103 comprises from as few as one to as many as millions of individual sensors 301. The number of elements in the array 103 impacts the response time of the system, and can be determined based on gas dynamic considerations of reducing the risk of shock waves in front of the array 103. Every element in the heat flux sensor array 103 can be individually addressed, for example, via electrical indexing of row and column electrodes or commonly operated, or mixtures thereof.

FIG. 3 shows an exemplary embodiment of an individual nanoscale-sized heat flux sensor 301 with a multi-layer structure deposited on a substrate. Two lower layers 308, 309 are n-type and p-type thermoelectric materials, the intermediate layer is a detection layer/top interconnect membrane 307, and the upper layer is a mask 303. The mask 303 has a window 302 in the center that provides access to the active zone of the heat flux sensor 301 for the impinging particles. For example, the mask 303 is disposed over the top interconnect membrane 307, and has a window 302 which exposes a portion of the top interconnect membrane 307.

In an exemplary embodiment, the heat flux sensor 301 includes a base 304 on which are disposed the first and second electrical connections 305, 306. The base 304 may be made of silicon or other suitable material. The electrical connections 305, 306 can be made of any suitable conductive material such as sufficiently doped silicon or metal such as copper. In an exemplary embodiment, the heat flux sensor 301 includes a nanoscale P-type thermoelectric material 308 between the top interconnect membrane 307 and the first electrical connection 305, and a nanoscale N-type thermoelectric material 309 between the top interconnect membrane 307 and the second electrical connection 306, wherein the heat flux sensor 301 is configured to be maintained at the temperature by current running through the nanoscale P-type thermoelectric material 308 and the nanoscale N-type thermoelectric material 309. Exemplary thermoelectric materials include, e.g., Bismuth telleride, antimony telleride, lead telleride, based materials, whose ideal stoichiometries and additional dopants are well known.

For example, the heat flux sensor 301 is built on the frontal side of a non-conductive substrate/base 304, which can be actively cooled from the rear side by a thermoelectric (e.g., Peltier) cooler. The individual heat flux sensor 301 can be produced by overlaying two separate layers of thermoelectric materials 308, 309—one with a positive type of conductivity (p-type semiconductor) and the other with the negative conductivity (n-type semiconductor), and a thin conductive detection layer/top interconnect membrane 307. This conductive detection layer/top interconnect membrane 307 represents a transducer that converts the energy of impinging particles to the thermal energy of the conductive detection layer/top interconnect membrane 307. The increase of the thermal energy in the form of phonons spreads from the point of the impact across the conductive detection layer/top interconnect membrane 307, therefore causing an almost instant increase in the temperature of this layer.

In an exemplary embodiment, the transducer is temperature controlled. In exemplary embodiments, the temperature of the transducer alternates between a range of temperatures. In an exemplary embodiment, a device 130 is configured to connect to the electrical connections 305, 306 and to provide current therethrough, for example to maintain the top interconnect membrane 307 at a temperature.

In exemplary embodiments, a transducer/conductive detection layer/top interconnect membrane 307 converts energy carried by impinging molecules into phonons or vibrational excitation of states of molecules on the surface of the transducer. In exemplary embodiments, the heat capacity of the transducer is less than 1,000,000 times the heat capacity of the analyte particle. In exemplary embodiments, the heat capacity of the transducer is less than 10,000 times the heat capacity of the analyte particle. In exemplary embodiments, the heat capacity of the transducer is less than 100 times the heat capacity of the particle to be analyzed.

For example, particles that collide with an individual heat flux sensor 301 increase its thermal energy, and due to sensor's very small heat capacity, its internal temperature increases depending on the molecule velocity and mass. The increase in sensor internal temperature can result in the generation of electric current due to the Seebeck effect of the thermoelectric material of the elements. The pulse of the electric current is amplified by using an operational amplifier, and recorded using an analog-to-digital conversion board connected to a computer, such as the device 130. Based on the Seebeck, the temperature difference between two dissimilar electrical conductors or semiconductors can be converted into a voltage difference between them. This effect, extended to the nanoscale, allows for nanoscale thermo-electric junctions to respond to impinging gas particles through a change in voltage. The voltage change depends on the change in energy of the incident and reflected particles. Such a change in energy, when recorded and calibrated for example by the device 130 described below, can provide information on individual particles colliding with the nanoscale junctions.

In an exemplary embodiment, to limit access of jet molecules to sensitive areas of the heat flux sensor 301, a non-conductive mask 303 covers the entire area of the heat flux sensor 301 except a small region that represents the detection area. In exemplary embodiments, the detection area is not larger than hundreds of square nanometers, so that each collision event can be registered individually. For example, for a 10 nm by 10 nm sized detection layer, the number flux of molecules in a jet of helium can be on the order of 10 million collisions per second.

In exemplary embodiments, the heat flux sensor 301 or the heat flux sensor array 103 is/are communicatively connectable—by wired or wireless connection—to a device 130 including memory and a processor programmed to determine absolute species concentration, mass, and/or heat capacity of the analyte particle from electrical signals from the nanoscale P-type thermoelectric material 308 and the nanoscale N-type thermoelectric material 309, for example by determining the impact energy carried by an impinging analyte particle. In exemplary embodiments, the electrical connections 305, 306 are communicatively connectable—by wired or wireless connection—to the device 130. In an exemplary embodiment, the device 130 is further configured, as described above, to connect to the electrical connections 305, 306 and to provide current therethrough, for example to maintain the top interconnect membrane 307 at a temperature.

In an exemplary embodiment, the device 130 is configured to compare the energy carried by the impinging analyte particle and compare and correlate such energy to predetermined values—such as values indicative of signals produced by known species and/or theoretical estimates—to determine a characteristic of the analyte particle. These predetermined values can be acquired by calibrating the sensor against known species and recording the values. The values of species that have not been calibrated against can be interpolated, computed and or estimated based on the values of the known species.

In an exemplary embodiment, the apparatus 101 comprises a detection chamber 110 housing the heat flux sensor 301.

In an exemplary embodiment, the emitter 120 includes an opening 106 in the detection chamber 110 allowing the analyte particle to be ejected from outside the detection chamber 110, into the detection chamber 110, onto the heat flux sensor 301, due to a pressure difference between inside the detection chamber 110 and outside the detection chamber 110.

In an exemplary embodiment, the detection chamber 110 includes an outlet 102 allowing the analyte particle to travel to an environment of lower pressure than a pressure of the detection chamber 110. For example, the pressure of the detection chamber can below ambient, below 1 Torr, below 0.01 Torr, or below any desired value.

In an exemplary embodiment, the detection chamber 110 is temperature controlled. This can be done with a resistive heater, thermoelectric module, a fluid at a known temperature, and/or with other methods of temperature control.

In an exemplary embodiment, the opening 106 is a supersonic nozzle 106. In exemplary embodiments, a supersonic nozzle 106 can help distribute lighter particles to edges of the heat flux sensor heat flux sensor array 103, and heavier particles to its center. In exemplary embodiments, the supersonic nozzle 106 is operated in a pulsed regime.

In exemplary embodiments, a gas jet expanding from a supersonic nozzle 106 can accelerate embedded particles to high velocities, up to several kilometers per second depending on the stagnation temperature and the carrier gas species. The jet terminal velocities v can be calculated from kinetic gas theory. The accelerated particles have kinetic energies E that can reach tens of eV depending on the molecular mass and terminal velocities reached in the expanding jet. When such hyper-thermal particles collide with the surface of a nanoscale sensor such as the heat flux sensor 301, the impinging particles add their kinetic and internal energies to the total thermal energy of the heat flux sensor 301. The resulting increase in temperature of the heat flux sensor 301 is directly proportional to the kinetic and internal energy of the impinging particle and the heat capacity of the heat flux sensor 301. The heat flux sensor 301 converts the excess of thermal energy into pulsed electric signals. Due to the fact that carrier gas velocity v can be measured or calculated with high precision, and the velocities of embedded particles are very close to the carrier gas velocities, particle mass m can be calculated, for example using the device 130, from the expression E=0.5·m·v².

In an exemplary embodiment, the emitter 120 includes a stagnation chamber 112 configured to contain the analyte particle at a pressure higher than a pressure inside the detection chamber 110, and arranged such that the opening 106 communicates between the stagnation chamber 112 and the detection chamber 110. In exemplary embodiments, the stagnation chamber 112 allows for mixing of chemical species to be analyzed with a carrier gas, for example, at atmospheric pressure.

In an exemplary embodiment, the carrier gas is any one of hydrogen (H₂), helium (He), air and or other suitable gases. The choice of carrier gas determines the velocities of the embedded particles, with lighter gases resulting in higher sensitivity. The carrier gas can be automatically detected by the sensor 301 or manually selected in software.

In an exemplary embodiment, the stagnation chamber 112 is maintained at atmospheric pressure, and the detection chamber 110 is maintained at a lower pressure, for example, but not limited to about 0.1 Torr. The volume of the detection chamber 110 can depend on the application and may vary from microliters to several liters. The stagnation chamber 112 can be used to mix carrier gas with an analyte species. The analyte species can be added to the carrier gas introduced to the stagnation chamber 112 due to its volatility. It can be also added via sublimation or evaporation of analyte molecules using a heat source. The detection chamber 110 can be used for analyte species detection, and can include or be coupled (e.g., via a valve 102) to a roughing or turbomolecular pump to keep the detection chamber 110 at a desired pressure.

In an exemplary embodiment, the emitter 120 includes an inlet 104 allowing the analyte particle to enter the stagnation chamber 112. In exemplary embodiments, the inlet 104 includes an inlet one-way valve 105.

In an exemplary embodiment, the stagnation chamber 112 is temperature controlled. For example, the emitter 120 can include a heater 107, a temperature sensor 108 and a pressure gauge 109 configured to vary and monitor a speed of the analyte particle inside the stagnation chamber 112.

A exemplary method of measuring a characteristic of an analyte particle comprises maintaining a sensing surface 3071 at a temperature, ejecting an analyte particle to cause the analyte particle to collide with the sensing surface 3071, detecting heat flux of the sensing surface 3071 due to the analyte particle colliding with the sensing surface 3071, and determining a characteristic of the analyte particle based on the detected heat flux of the sensing surface 3071.

An exemplary method of measuring a characteristic of an analyte particle is performed without ionization of the analyte particle.

In an exemplary method, a detection chamber 110 houses the heat flux sensor 301, and an opening 106 in the detection chamber 110 allows the analyte particle to be ejected from outside the detection chamber 110, into the detection chamber 110, onto the heat flux sensor 301, due to a pressure difference between inside the detection chamber 110 and outside the detection chamber 110.

In an exemplary method, the opening 106 is a supersonic nozzle 106. In exemplary embodiments, the supersonic nozzle expands analyte particles, or carrier gas and embedded analyte particles, into the downstream detection chamber 110, which can be maintained at sub-atmospheric pressure. The supersonic nozzle 106 can provide necessary aerodynamic acceleration and directionality to carrier gas and/or embedded analyte species.

In an exemplary method, the supersonic nozzle 106 ejects the analyte particle from an open space into the detection chamber 110.

In an exemplary method, the supersonic nozzle 106 ejects the analyte particle from a stagnation chamber 112 into the detection chamber 110.

In an exemplary method, the sensing surface 3071 is a surface of a top interconnect membrane 307 of a heat flux sensor 301, and the heat flux sensor 301 includes a nanoscale P-type thermoelectric material 308, a nanoscale N-type thermoelectric material 309, and the top interconnect membrane 307 bridging the nanoscale P-type thermoelectric material 308 and the nanoscale N-type thermoelectric material 309.

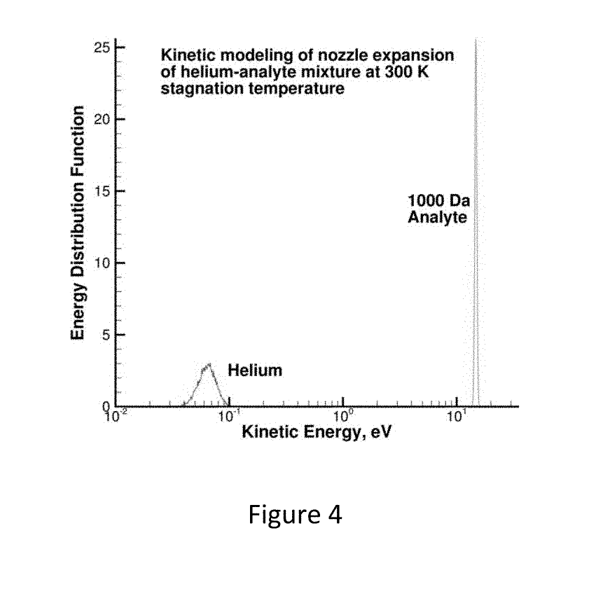

FIG. 4 shows an energy distribution of two molecular species of different masses in the far field of the plume ejected through a nozzle 106. The distribution is bimodal, with separate peaks for the lighter species (carrier gas) and heavier species to be analyzed. The separation of species in the energy space can allow for precise quantification of the energy distribution of molecules that reach the heat flux sensor array.

In an exemplary method, the first is the intake of analyte particles and mixing of such analyte particles with carrier gas. Non-limiting examples of such intake include direct air sampling, heating of a sample to cause sublimation or evaporation of analyte particles from its surface, and laser ablation. After the analyte particles are embedded into the carrier gas, the flow is directed toward a converging-diverging nozzle 106 that connects the stagnation chamber 112 and the detection chamber 110 as illustrated in FIG. 1. The primary mechanism for gas transport in exemplary embodiments is the pressure difference between the chambers.

In an exemplary method, the jet expansion through the nozzle 106 results in the transformation of the thermal energy of gas in the stagnation chamber 112 into the kinetic energy of the jet. Optimum nozzle geometry can provide a uni-directional flow with very low divergence, depending on the specific pressures used in the stagnation and detection chambers 112, 110. The terminal jet velocity is determined by the gas temperature of the stagnation chamber and the molecular weight of the carrier gas species: the higher the gas temperature and the lighter the gas, the higher the jet terminal velocity. For example, while for a molecular nitrogen flow with a stagnation temperature of 300 K the terminal velocity is about 800 m/s, helium expansion with a stagnation temperature of 500 K results in a terminal velocity of about 2,300 m/s. The embedded analyte molecular species acquire velocities close to the terminal velocity of the jet through collisions with atoms or molecules of the carrier gas expanding through the nozzle.

In an exemplary method, the kinetic energy of the embedded analyte particles can be calculated using the expression E=0.5·m·v², where m is the mass and v is the velocity of the particles. For example, the kinetic energy of a 1,000 Da particle accelerated in the jet to 2,300 m/s is equal to 27 eV, while the energy of helium atoms traveling with that velocity is only about 0.1 eV. It is important that in the expanding jet, as the thermal energy is converted to the kinetic energy, the thermal velocities of the carrier gas and analyte particles become small, with the corresponding translational temperatures typically below 10 K. As such, the distributions of energies of the analyte and carrier species may easily be separated, as shown in FIG. 4, and the mass of the analyte can be obtained from the energy distribution and the known terminal velocity. The jet terminal velocity may be calculated using the following expression

$${U}_{terminal} = \sqrt{\frac{2 \cdot {C}_{p} \cdot {T}_{0}}{m}} ,$$

where Cₚ is the carrier gas heat capacity at a constant pressure, and T₀ is the temperature in the stagnation chamber. The energy of the imbedded species can be assessed by converting this energy into a measurable parameter. For example, a conversion of the kinetic energy of analyte particles into thermal energy during their collisions with a nanoscale sized sensor, which has very small heat capacitance, can be used. Assuming a fully diffuse accommodation at the sensor surface, the average translational energy of reflected analyte molecules is calculated as 2·k·Tₛ, where Tₛ is the temperature of the substrate. For an actively cooled sensor kept at −80 C, the energy of a reflected analyte molecule is approximately 0.03 eV, which amounts to 0.1% of the incoming molecule energy. While this can contribute to the error bar of the conversion efficiency, more detailed knowledge of the specifics of the analyte-sensor interaction can significantly adjust that error bar.

In an exemplary method, for a 5 nm thick detection layer, a collision of a 1,000 Da molecule traveling at 2,300 m/s will result in an increase of the surface temperature by approximately 1.4 K. Such a temperature jump can be measured due to the Seebeck effect provided by the thermoelectric element. With a typical Seebeck coefficient of 300 μV/K (See Ai. I. Boukai et al, Silicon nanowires as efficient thermoelectric materials, Nature 451, 168-171, 2008, incorporated herein by reference for its description of determining or measuring a temperature jump due to the Seebeck effect), the resulting pulse signal is about 0.5 mV. This voltage pulse is recorded using a low-noise preamplifier (collision detector). The collision detector can be an operational amplifier with very low voltage noise, an individual transistor, or superconducting quantum interference device (SQUID) detector. Assuming that the nanoscale detecting layer temperature cools down to the baseline level in 1 ms, one can estimate the bandwidth of the operational amplifier that processes the signal to be about 0.01 MHz. Most operational amplifiers have voltage-noise characteristics of about 1 nV/\sqrt{Hz}, so the noise contribution to the magnitude of a 1 ms peak will be significantly lower than 1 mV. The signal-to-noise ratio will therefore be about over 1,000. The estimate for the mass resolution m/□m is thus about 500. Using, for example, ten parallel amplifiers for one sensor, one can decrease the noise by a factor of three, thus increasing m/□m to 1,500.

In an exemplary apparatuses and methods, the geometry and operating parameters of the disclosed device can be adjusted and fine-tuned using numerical/analytical as well as experimental means, and generally can be the subject of optimization. The numerical/analytical optimization may proceed through iterations and can be represented by the following algorithm:

Model Evolution Algorithm

```
      Set C # model constraints
      Set P # set of search parameters
      Set M # initial approximation of the mass spectrometer model
      Do While performance criteria K are not met
            Do While numerical solution accuracy A is not reached
                  Run continuum flow solver for high density nozzle
                  flow using C
                  Run kinetic gas flow solver using C and the
above continuum solution
                  Run solid heat transfer model of thermoelectric
junctions using C and the flow solution
                  Run molecular dynamics solver using flow
and heat transfer solutions
                  Obtain integrated signal solution S
            End Do
            Update M using S and P
      End Do
```

In an exemplary apparatuses and methods, the optimization can be based on key geometric, flow, and surface parameters P, such as the dimensions and location of the sensors and the nozzle, carrier gases, pressure in the detection chamber, temperatures and materials of all surfaces of the sensor array and the nozzle, specific geometry of thermoelectric junctions and their mounts, etc. It has to be bound by a set of constraints C such as preferred analyte species, total volume of the device, pump type, input electric power, and materials and/or manufacturing process. The optimization can follow end-of-optimization criteria K, such as desired detection accuracy and response time. Numerical optimization loop may use all or some of the following solvers: continuum flow solver based on the Navier-Stokes equations to model initial compression and expansion inside the nozzle, kinetic solver to model expanding gas jet and flow over the sensor array, solid heat conduction solver to model current and heat transfer in the thermoelectric junctions and mounts, and the molecular dynamic method for solving the Newtonian equations of motion for the interaction of analyte particles with the sensor surface. The latter may include surface chemistry as an additional parameter. Numerical optimization may be followed by experimental optimization. The experimental optimization can to a large extent be guided by the numerical optimization, complement it, and be focused on validating or correcting the numerical simulation and establishing the actual, real-life parameters of performance.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An apparatus for measuring a characteristic of an analyte particle, the apparatus comprising:
a heat flux sensor configured to be maintained at a temperature, the heat flux sensor including first and second electrical connections, and a top interconnect membrane bridging the first and second electrical connections; and
an emitter configured to eject an analyte particle to cause the analyte particle to collide with the top interconnect membrane of the heat flux sensor.

2. The apparatus for measuring a characteristic of an analyte particle according to claim 1, the apparatus comprising:
a device communicatively connected to the heat flux sensor and configured to compare an energy carried by the analyte particle colliding with the top interconnect membrane of the heat flux sensor and compare and correlate the energy to predetermined values, to determine a characteristic of the analyte particle.

3. The apparatus for measuring a characteristic of an analyte particle according to claim 1, wherein the top interconnect membrane is configured to convert energy carried by the analyte particle colliding with the top interconnect membrane into phonons or vibrational excitation of states of molecules on a surface of the top interconnect membrane.

4. The apparatus for measuring a characteristic of an analyte particle according to claim 1, the apparatus comprising:
a heat flux sensor array including a plurality of heat flux sensors, the sensor being one of the plurality of heat flux sensors (301).

5. The apparatus for measuring a characteristic of an analyte particle according to claim 1, the heat flux sensor including:
a mask, disposed over the top interconnect membrane, and having a window which exposes a portion of the top interconnect membrane.

6. The apparatus for measuring a characteristic of an analyte particle according to claim 1, the heat flux sensor including:
a base on which are disposed the first and second electrical connections.

7. The apparatus for measuring a characteristic of an analyte particle according to claim 1, the heat flux sensor including:
a nanoscale P-type thermoelectric material between the top interconnect membrane and the first electrical connection; and
a nanoscale N-type thermoelectric material between the top interconnect membrane and the second electrical connection,
wherein the heat flux sensor is configured to be maintained at the temperature by current running through the nanoscale P-type thermoelectric material and the nanoscale N-type thermoelectric material.

8. The apparatus for measuring a characteristic of an analyte particle according to claim 1, the apparatus comprising:
a detection chamber housing the heat flux sensor,
wherein the emitter includes an opening in the detection chamber allowing the analyte particle to be ejected from outside the detection chamber, into the detection chamber, onto the heat flux sensor, due to a pressure difference between inside the detection chamber and outside the detection chamber.

9. The apparatus for measuring a characteristic of an analyte particle according to claim 8, the detection chamber including:
an outlet allowing the analyte particle to travel to an environment of lower pressure than a pressure of the detection chamber.

10. The apparatus for measuring a characteristic of an analyte particle according to claim 8, wherein the opening is a supersonic nozzle.

11. The apparatus for measuring a characteristic of an analyte particle according to claim 8, the emitter including:
a stagnation chamber configured to contain the analyte particle at a pressure higher than a pressure inside the detection chamber, and arranged such that the opening communicates between the stagnation chamber and the detection chamber; and
an inlet allowing the analyte particle to enter the stagnation chamber.

12. The apparatus for measuring a characteristic of an analyte particle according to claim 11, wherein the stagnation chamber is temperature controlled.

13. A method of measuring a characteristic of an analyte particle, the method comprising:
maintaining a sensing surface at a temperature;
ejecting an analyte particle to cause the analyte particle to collide with the sensing surface;
detecting heat flux of the sensing surface due to the analyte particle colliding with the sensing surface; and
determining a characteristic of the analyte particle based on the detected heat flux of the sensing surface.

14. The method of measuring a characteristic of an analyte particle according to claim 13, performed without ionization of the analyte particle.

15. The method of measuring a characteristic of an analyte particle according to claim 13, wherein a detection chamber houses the heat flux sensor, and an opening in the detection chamber allows the analyte particle to be ejected from outside the detection chamber, into the detection chamber, onto the heat flux sensor, due to a pressure difference between inside the detection chamber and outside the detection chamber.

16. The method of measuring a characteristic of an analyte particle according to claim 15, wherein the opening is a supersonic nozzle.

17. The method of measuring a characteristic of an analyte particle according to claim 16, wherein the supersonic nozzle ejects the analyte particle from an open space into the detection chamber.

18. The method of measuring a characteristic of an analyte particle according to claim 16, wherein the supersonic nozzle ejects the analyte particle from a stagnation chamber into the detection chamber.

19. The method of measuring a characteristic of an analyte particle according to claim 13, the sensing surface being a surface of a top interconnect membrane of a heat flux sensor, the heat flux sensor including:
a nanoscale P-type thermoelectric material, a nanoscale N-type thermoelectric material, and the top interconnect membrane bridging the nanoscale P-type thermoelectric material and the nanoscale N-type thermoelectric material.

20. The method of measuring a characteristic of an analyte particle according to claim 19, wherein the top interconnect membrane converts energy carried by the analyte particle colliding with the top interconnect membrane into phonons or vibrational excitation of states of molecules on the sensing surface of the top interconnect membrane.
